(19) United States
(12) Patent Application Publication
(10) Pub. No.: US 2005/0201576 A1
(43) Pub. Date: Sep. 15, 2005

(54) Mars suit external audion system

(75) Inventors: Donald Carl Barker, Houston, TX (US); Gregory T. Delory, San Francisco, CA (US)

Correspondence Address: Mr. Donald C. Barker, P.O. Box 58915, Houston, TX, 77058, US

(73) Assignee: Mr. Donald C. Barker, Houston, TX (US)

(21) Appl. No.: 11/070,487

(22) Filed: Mar. 2, 2005

Related U.S. Application Data
(60) Provisional application No. 60/549,279, filed on Mar. 3, 2004.

(51) Int. Cl. H04R 5/02; H04B 1/00; H04R 1/02

(52) U.S. Cl. 381/301; 381/333; 381/388

(57) ABSTRACT

Apparatus, systems and methods are provided for a planetary suit audio system that allows a suited occupant to acoustically interact, using three dimensional surround sound and directional accuracy, with and within the ambient surface environment. This is being developed directly for integration into future versions of a Martian surface suit. The hardware and apparatus incorporates a system that requires a low power suit interface, an intelligent digital signal processing (DSP) sound chip, appropriately integrated and tested sound processing Head-Related Transfer Function (HRTF) algorithms, integrated communications system circuitry, miniaturized electric eternal microphone arrays and speakers, and occupant used internal suit speakers or headsets. It has been found that the pressure at the Martian surface (equivalent to 99,000 feet in altitude on the Earth) supports the appropriate acoustical properties to allow for standard environmental auditory interaction. Exploration of the surface of Mars will require crews to routinely work within the confined spaces of environmental pressure suits during missions lasting as much a 500 days. The use of traditional suits means that operators have to adapt to an internal environment that limits the amount of direct sensory interaction with the external environment. Incorporating external audio capabilities has a major impact of providing the extravehicular activity (EVA) or surface operations crewmember with a second natural means of interacting with, and exploring their environment. This will also make the operating environment more tangible and comfortable for daily operations. Given this apparatus, crews will have the ability to judge actions, environmental conditions, and equipment operations based on auditory inputs, thus promoting increased operational safety and mission success.

### TECHNICAL FIELD OF THE INVENTION

The present invention relates generally to the outfitting of any surface or planetary pressure suit with an audio system that allows the user to acoustically interact with the ambient environment. This includes, but is not limited to, ambient environmental sounds, audio communications between other so outfitted persons or robots/facilities outfitted with similar acoustic interfaces.

### BACKGROUND OF THE INVENTION

Given that Mars surface EVA Operations have been proposed to commence somewhere between 2015 and 2030, there exists a need for providing astronauts working on the surface of atmosphere sustaining worlds, such as Mars, an alternate means of communication, either as a primary or as a backup to radio communications, by taking direct advantage of the available acoustic medium. Electronic acoustic hearing aid type devices employing microphone receivers are known. Supporting this effort we are developing the Mars Suit External Audio System; a sensor system suite that will increase the safety, autonomy and enhance the productivity of crew surface operations. This invention provides future crews or environmentally confined operators with the means of applying and using their innate audio-perceptual capabilities during operations in novel, unique and confined environments.

The Mars Suit Audio External Audio System is an external audio sensor system that will provide ambient surround sound acoustic interface for future Mars Extra Vehicular Activity (EVA) suits or Planetary Surface Suits where the ambient atmosphere provides sufficient acoustic transfer properties. The system we are developing utilizes advances in sound processing technology to produce a planetary EVA suit communications system that would give the occupant a high fidelity aural-perceptual connection to the external Martian (planetary surface) environment (See Schematic 1 & 2). In such a system, a suite of externally mounted suit microphones collects acoustic signals that are then recorded and digitally processed to yield instant information (e.g., directional information) of the sound source to the suit occupant. In addition, the integration of an externally mounted speaker system provides a redundant means of communication between EVA crewmembers equipped with audio sensors. This system can therefore act as either a primary or redundant means of inter-crew communication during planetary surface operations. In addition, this system provides the additional ability for crewmembers to interact with other local voice activated or interactive equipment (e.g., robotic assistants). This system would be the first of its kind to provide a human operator with direct acoustic information within a non-terrestrial atmosphere. This technology is highly relevant human exploratory operations on planetary surfaces by enhancing and increasing safety, productivity and situational awareness of future explorers. Derivative commercial systems could potentially be integrated into any confined human occupied environment or remotely operated vehicle application, including environmental isolation suits, firefighting gear, underwater suits and Mars surface Remotely Operated Vehicles (ROVs).

The utility of real-time acoustic feedback is gaining an increasing importance in a variety of operational environments where user situational awareness is at a premium. To date, no EVA system used for space flight has included any capability to reproduce external audio signals for use by the suit occupant and the only acoustic interface has included radio (RF) communications. This is not surprising given that the most common operational uses for EVA suits have taken place in the vacuum of low Earth orbit or on the surface of the Moon, where a transmission medium for environmental sounds to the suit occupant were either non-existent or could only result from some type of mechanical coupling to the suit structure itself. The eventual sending of humans to explore the surface of Mars however forces a re-examination of this issue. While the atmosphere on the surface of Mars is thin, with a mean pressure less than 1% of the terrestrial sea-level pressure, theoretical calculations and laboratory measurements indicate that sound levels are reduced by only ˜20 decibels in intensity relative to similar sounds on Earth. Such a sound reduction amounts to a moderate hearing loss in humans and can easily be accounted for using existing microphone sensor technology and amplifying electronics.

The application and utility of a Mars EVA suit audio system spans issues that range from crew health and safety to worker productivity. With some mission scenarios calling for a human presence on Mars of up to 500 days with multiple surface reconnaissance, scientific and maintenance excursions, acoustic feedback of everyday activities such as tool use, construction, and maintenance tasks will prove to be a crucial element in long-term operations. This capability provides the EVA crewmember with a second natural means of interacting with and exploring the external environment, thereby making the experience more tangible and comfortable for daily operations. Examples include the ability to listen to machinery that may emit altered sounds during a malfunction, direct acoustic feedback during tasks requiring hammering or drilling processes, or the sound of a properly closing hatch or airlock door. Beyond issues of human productivity, one can consider the safety implications of an audio system, including the ability to hear possibly hazardous events occurring around the EVA crewmember such as dust devils, avalanches, or falling objects or equipment. With the utility of external audio sensors for Mars surface EVA a given, the inclusion of a suit loudspeaker is a next natural consequence, enabling this system to act either as a primary means of suited communication or as a backup communication system between EVA crewmembers in the event of a radio (RF) communications failure. In addition, EVA crewmembers will have the ability to communicate and command voice controlled robotic equipment and could be appraised of possible emergency events broadcast by malfunctioning hardware or a base wide speaker alert system.

### SUMMARY OF THE INVENTION

The above mentioned problems and unique constraints placed on suited planetary surface operators are addressed by the present invention and will be understood by reading and studying the following specification. Apparatus, systems and methods are provided for a complete audio sensor system for a Mars surface EVA suit and would consist of mounting microphones externally on the helmet, whose number and spacing would depend on the amount of directional sound information that is desired for the user. Onboard digital signal processing (DSP) electronics would then account for the known acoustic receptive properties of the helmet/suit system and compensate, while also adjusting the output signal into the headphones or suit speakers to compensate using an HRTF filter for the human eardrum to atmosphere interface, so that the received sound is virtually re-created for the occupant. The acoustic sensors are small, thumbnail sized devices that can be ruggedized for harsh environments. DSP-based sound processing can be scaled to fit suit resources in terms of size, mass, and power, and also integrated with existing suit communications systems for additional consolidation of resources. A speaker with a simple audio amplifier as a driver for external communications would be mounted on the chest of the suit, and would similarly consist of ruggedized off-the-shelf hardware as with the microphones.

These and other aspects, embodiments, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIGS. 1 and 2 illustrate views for a sample embodiment of an electronic circuit comprising of external microphones and speakers and an internal speaker array according to the teachings of the present invention.

FIG. 3 illustrates views for another embodiment of the external electronic microphones and speakers on a pressure suit according to the teachings of the present invention;

### DETAILED DESCRIPTION OF THE INVENTION

In the following detailed description of the invention, reference is made to the accompanying drawings which form a part hereof, and in which is shown, by way of illustration, specific embodiments in which the invention may be practiced. The embodiments are intended to describe aspects of the invention in sufficient detail to enable those skilled in the art to practice the invention. Other embodiments may be utilized and changes may be made without departing from the scope of the present invention. The following detailed description is, therefore, not to be taken in a limiting sense, and the scope of the present invention is defined only by the appended claims, along with the full scope of equivalents to which such claims are entitled. The present invention is drawn to, among other things, apparatus, systems and methods for a complete audio sensor system designed to offer suited occupants complete aural interaction within a planets atmosphere.

In addition, the system of the present invention includes software operative on a processor to perform methods according to the teachings of the present invention. One of ordinary skill in the art will understand, upon reading and comprehending this disclosure, the manner in which a software program can be launched from a computer readable medium in a computer based system to execute the interactive functions defined in the software program. However, as will be appreciated by one of ordinary skill in the art upon reading this disclosure, the teachings of the present invention are not limited to a particular programming language or environment, Central to the success of a Mars surface EVA suit audio system is obviously a realistic reproduction of exterior sounds. Ideally, the reproduction of exterior sounds would retain the most useful element of the acoustic experience for the user aside from the presence of the sound itself, and that is the relative direction of the source. Most recordings played back over speakers or headphones are spatially flat, i.e., they have lost much of the 3-D depth of the original sound that we would otherwise experience if a listener was present near the original sound source. However when humans hear sounds in the real environment in which they are generated, spatial localization of these sounds can be accurate to within a few degrees of azimuth relative to the listener. Research into the mechanisms behind sound localization in humans began over 120 years ago when Lord Rayleigh suggested that sound level differences between the ears should give the necessary cues for sound localization. Subsequent research has shown that this effect, known as the inter-aural level difference (ILD), was only one component of a multitude of cues used by humans in sound localization; of equal or sometimes even greater importance are arrival time differences of sound between the ears, known as the inter-aural time difference, (ITD), as well as spectral shifts introduced to received sounds due to individual geometry of the ears, head, and other local anatomical differences that produce directionally dependent interference. Thus a simple stereo playback of sounds over headphones at most reproduces a third of the sound picture, and is insufficient in many cases to retain any meaningful spatial relationships present in the original source sound field. The detailed study of these spatial auditory cues is called psychoacoustics, and within the last decade a detailed understanding of ITDs, ILDs, and sound modification due to anatomical features around the head and ears has enabled these effects to be reproduced digitally over headphones or speakers. These approaches use the Head-Related Transfer Function, (HRTF), which is in essence a filter that accounts for all of the known spatial auditory cues for a given listener. This function can be reduced to a digital processing algorithm that can then be used in a variety of applications involving sound reproduction over headphones or speakers.

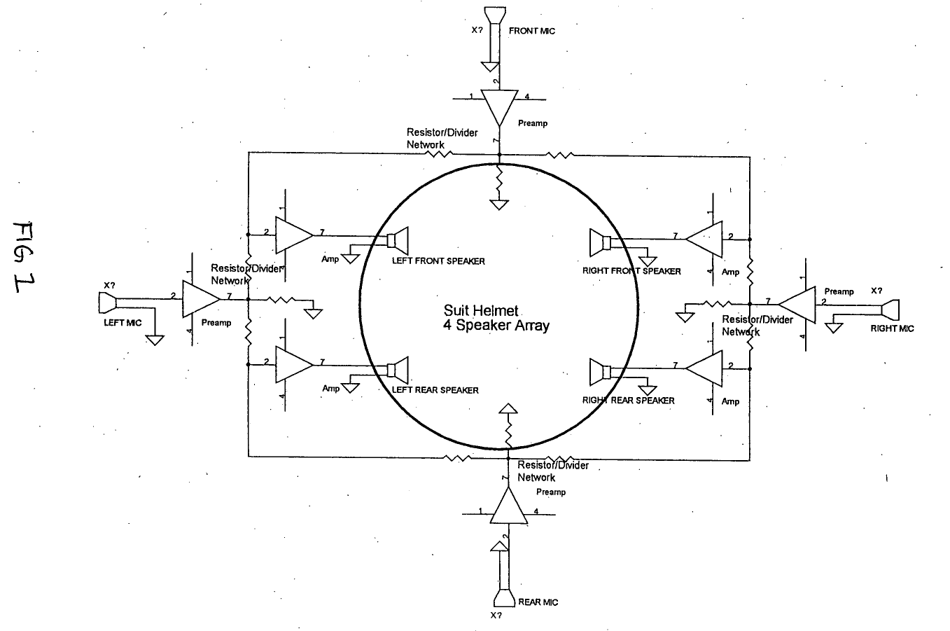

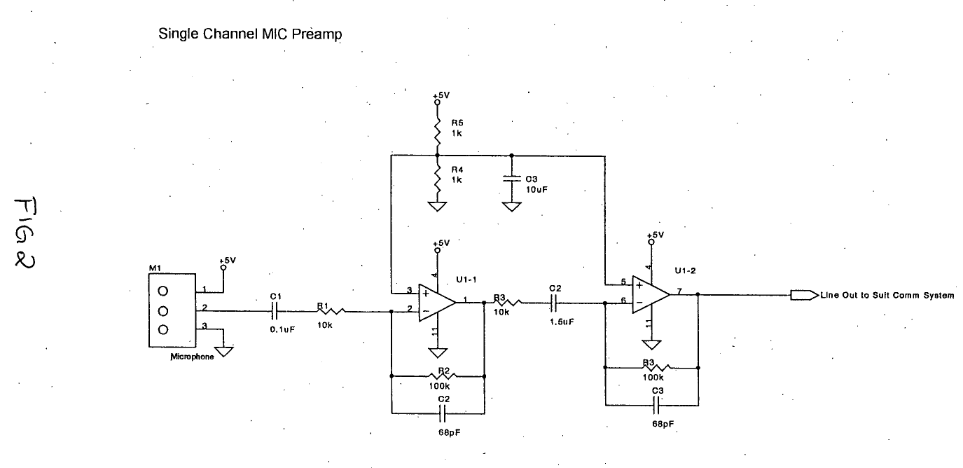

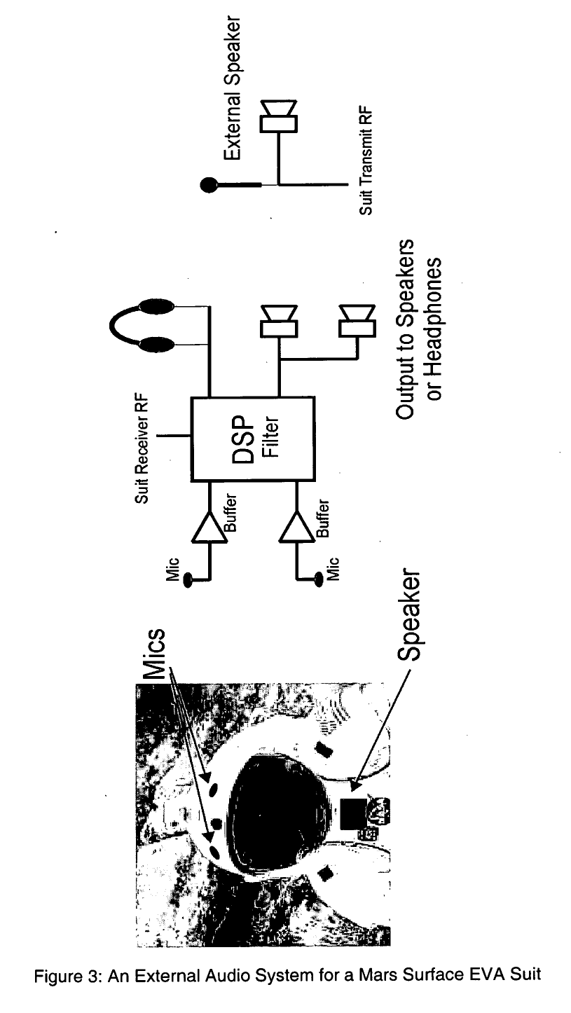

A complete audio sensor system for a Mars surface EVA suit would consist of mounting or incorporating in structure, microphones externally on the helmet, whose number and spacing would depend on the amount of directional sound information that is desired for the user (See FIGS. 1 & 2). Onboard digital signal processing (DSP) electronics would then account for the known acoustic receptive properties of the helmet/suit system and compensate, while also adjusting the output signal into the headphones or suit speakers to compensate using an HRTF filter for the human eardrum to atmosphere interface, so that the received sound is virtually re-created for the occupant. The acoustic sensors are small, thumbnail sized devices that will be ruggedized for harsh environments. DSP-based sound processing will be scaled to fit suit resources in terms of size, mass, and power, and also integrated with existing suit communications systems for additional consolidation of resources. A speaker with a simple audio amplifier as a driver for external communications would be mounted on the chest of the suit, and would similarly consist of ruggedized hardware as with the microphones (FIG. 3).

### CONCLUSION

The above systems, devices and methods have been described, by way of example and not by way of limitation, with respect to apparatus, systems and methods which incorporate the acquisition, processing and presentation of ambient acoustic environmental signals generated in a planetary atmosphere, processed and reproduced and presented for use by a suited occupant. Further, in some embodiments, the apparatus, systems and methods of acoustic processing for human use during planetary surface operations could be functionality associated with robotic or facility operations.

Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments and other embodiments will be apparent to those of skill in the art upon reviewing the above description. The scope of the invention includes any other applications in which the above systems, devices and methods are used. The scope of the invention should be determined with reference to the associated descriptions and claims, along with the full scope of equivalents to which such claims are entitled.

1. An external audio system for planetary surface pressure and environmental suits that allows a suited occupant to hear and communicate through the ambient atmosphere external to the suit.

2. The audio system of claim 1 includes a method of collecting ambient audio signals by an array of electronic transducers for use in a digital signal processor to process and integrate multiple signal inputs and provide digitally processed signals to suited user, said method comprising:
a. Multiple transducer microphone array
b. Digital signal processor electronics
c. Internal suit audio speaker projection transducers

3. The microphone transducers of claim 2 which said means for reliably attaching or integrating said microphones on the external surface with four transducers positioned at each side, a top and a bottom of said suit.

4. The digital signal processor of claim 2 which said comprises of appropriate and suitable electronic components and which interface with said microphone and said internal suit speakers.

5. The internal suit speaker transducers of claim 2 which said comprises of appropriate and suitable speaker transducers that adequately provide users with audio information.

6. The digital signal processor of claim 4 includes a method of reproducing external audio signals three dimensionally and with sufficient directionality so as to provide said suited occupant with an accurate representation of the external audio environment.

7. The audio system of claim 1 includes a means of interfacing providing digital telemetry with and between additional communications equipment of said suit.

8. The audio system of claim 1 includes a means of providing control access to said suit occupant.

9. The audio system of claim 1 includes a method for producing audio signals using a speaker transducer array mounted on the external surface of said suit.
